(19) United States
(12) Patent Application Publication
(10) Pub. No.: US 2020/0101796 A1
(43) Pub. Date: Apr. 2, 2020

(54) SNOW VICE CHANNELS

(71) Applicant: Bridgestone Americas Tire Operations, LLC, Nashville, TN (US)

(72) Inventors: David M. Severyn, North Canton, OH (US); Adam D. Singer, Massillon, OH (US); Kevin E. Scheifele, Atwater, OH (US)

(21) Appl. No.: 16/580,716

(22) Filed: Sep. 24, 2019

Related U.S. Application Data
(60) Provisional application No. 62/739,487, filed on Oct. 1, 2018.

(51) Int. Cl. B60C 11/13

(52) U.S. Cl. CPC B60C 11/1323; B60C 2011/1338

(57) ABSTRACT

A tire is provided comprising a tread. The tread includes a rib having a first axially-facing side and a second axially-facing side. A plurality of axial grooves traverse the rib, dividing the rib into a plurality of tread blocks. Each tread block includes one or more block sidewalls, where the one or more block sidewalls of each tread block includes a first axially-facing block sidewall and a second axially-facing block sidewall. A first circumferential groove is positioned on the first axially-facing side of the rib and a second circumferential groove positioned on the second axially-facing side of the rib. Furthermore, a first circumferentially-extending channel is provided on the first axially-facing block sidewall of each tread block and having an opening at the first circumferential groove and a first corner within each tread block. The first channel is defined by two walls that extend from the block sidewall into each tread block and intersect to form the first corner having about a 90 degree angle.

### CROSS-REFERENCE TO RELATED APPLICATIONS

This application claims priority to U.S. Provisional Patent Application No. 62/739,487, filed on Oct. 1, 2018, which is incorporated by reference herein in its entirety.

### BACKGROUND

Tires on vehicles may be exposed to a variety of road conditions. Such road conditions may include dry, wet, snowy, icy, muddy, rubbly, and the like. A tire may include certain tread features to improve performance for a particular road condition. For example, for enhanced snow performance, a tire tread may include tread features for optimizing snow traction. Such features may include tread elements along the ribs of the tread that may capture and retain snow. The elements may comprise one or more of a ridge, a channel, a passageway, a cut, or any other feature suited for capturing and holding snow. Upon contact with snowy ground, the tread features may hold snow, increasing snow-on-snow friction of the tire tread, and thereby improving the snow traction of the tire.

What is needed is a tire having tread features for improved snow performance.

### SUMMARY

In one example, a tire comprising a tread is provided, the tread having: a rib having a first axially-facing side and a second axially-facing side; a plurality of axial grooves that traverse the rib, dividing the rib into a plurality of tread blocks, wherein each tread block includes one or more block sidewalls; wherein the one or more block sidewalls of each tread block includes a first axially-facing block sidewall and a second axially-facing block sidewall; a first circumferential groove positioned on the first axially-facing side of the rib; a second circumferential groove positioned on the second axially-facing side of the rib; and a first circumferentially-extending channel provided on the first axially-facing block sidewall of each tread block and having an opening at the first circumferential groove and a first corner within each tread block, the first channel being defined by two walls that extend from the block sidewall into each tread block and intersect to form the first corner having about a 90 degree angle

In another example, a tire comprising a tread is provided, the tread having: a rib having a first axially-facing side and a second axially-facing side; a plurality of axial grooves that traverse the rib, dividing the rib into a plurality of tread blocks, wherein each tread block includes one or more block sidewalls and a block tread surface, wherein the one or more block sidewalls of each tread block includes a first axially-facing block sidewall and a second axially-facing block sidewall; a first circumferential groove positioned on the first axially-facing side of the rib; a second circumferential groove positioned on the second axially-facing side of the rib; a first circumferentially-extending channel provided on the first axially-facing block sidewall of each tread block and having an opening at the first circumferential groove and a first corner within each tread block, the first channel being defined by two walls that extend from the block sidewall into each tread block and intersect to form the first corner having about a 90 degree angle; and a second circumferentially-extending channel provided on the first axially-facing block sidewall of each tread block and having an opening at the first circumferential groove and a second corner within each tread block, the second channel being defined by two walls that extend from the block sidewall into each tread block and intersect to form the second corner having about a 90 degree angle, and wherein the second channel is positioned radially inward from the first channel

In a further example, a tire comprising a tread is provided, the tread having: a rib having a first axially-facing side and a second axially-facing side; a plurality of axial grooves that traverse the rib, dividing the rib into a plurality of tread blocks, wherein each tread block includes one or more block sidewalls and a block tread surface, wherein the one or more block sidewalls of each tread block includes a first axially-facing block sidewall and a second axially-facing block sidewall; a first circumferential groove positioned on the first axially-facing side of the rib; a second circumferential groove positioned on the second axially-facing side of the rib; a first circumferentially-extending channel provided on the first axially-facing sidewall of each tread block and having an opening at the first circumferential groove and a first corner within each tread block, the first channel being defined by two walls that extend from the block sidewall into each tread block and intersect to form the first corner having about a 90 degree angle; and a second circumferentially-extending channel provided on the second axially-facing sidewall of each tread block and having an opening at the second circumferential groove and a second corner within each tread block, the second channel being defined by two walls that extend from the block sidewall into each tread block and intersect to form the second corner having about a 90 degree angle.

### BRIEF DESCRIPTION OF THE DRAWINGS

Features, objects, and advantages other than those set forth above will become more readily apparent when consideration is given to the detailed description below. Such detailed description makes reference to the following drawings.

FIG. 1 depicts a sectional view of a tire.

FIG. 2 depicts a partial perspective view of a tire.

FIG. 3 depicts a sectional view of a portion of a rib of a tire.

FIG. 4 depicts a sectional view of a portion of a rib of a tire.

FIG. 5 depicts an elevational view of a portion of a rib of a tire.

FIG. 6 depicts a sectional view of a tire.

FIG. 7 depicts a sectional view of a tire.

FIG. 8 depicts a sectional view of a tire.

FIG. 9 depicts a sectional view of a tire.

### DETAILED DESCRIPTION

The structures illustrated in the drawings include examples of the features recited in the claims. The illustrated structures thus include examples of how a person of ordinary skill in the art can make and use the claimed invention. These examples are described to meet the enablement and best mode requirements of the patent statue without imposing limitations that are not recited in the claims. One or more of the features of one example may be used in combination with, or as a substitute for, one or more features of another as needed for any particular implementation of the examples described herein.

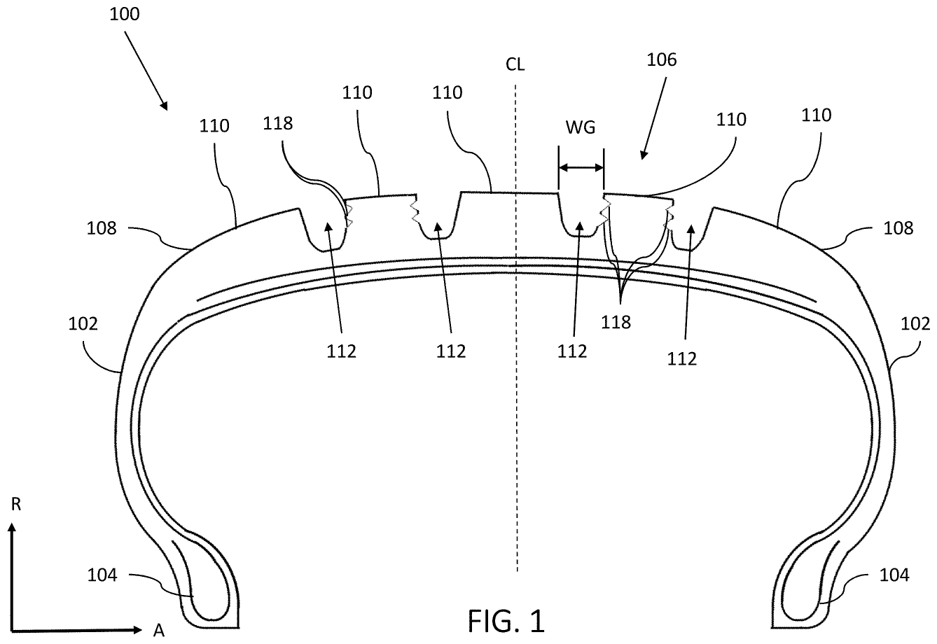

FIG. 1 depicts an example of a sectional view of a tire 100. Tire 100 may be one of a radial tire and a bias ply tire. Tire 100 may include any of a variety of pneumatic or non-pneumatic tires. Tire 100 may be configured for use for one of a passenger tire, a truck tire, a bus tire, an off-the-road tire, an ATV tire, an agricultural tire, and the like. Tire 100 may be configured for use in a tire constructed for operation on a roadway. Tire 100 may be one of a directional tire and a non-directional tire.

Tire 100 may include opposing sidewalls 102. Tire 100 may include opposing bead portions 104. Tire 100 may include a ground-contacting portion oriented between opposing sidewalls 102 that includes a tread 106 having opposing shoulder regions 108. In some instances, “opposing” describes a position of a second feature as to a first feature, such that the second feature is a mirror image of the first feature relative to a circumferential centerline CL (a line of reflection) of tire 100. For example, opposing shoulder regions 108 are a mirror image of each other relative to circumferential centerline CL, such that they are located at substantially identical positions on either side of centerline CL on tire 100. Alternatively, in other instances, “opposing” describes a position of a second sub-feature as to a first sub-feature, such that the second sub-feature is a mirror image of the first feature relative to a desired line of reflection of a feature including the sub-features.

FIGS. 1-10 include axes identified as “C,” “R,” and “A.” The C-axis is intended to represent a circumferential direction in tire 100. The R-axis is intended to represent a radial direction in tire 100. The A-axis is intended to represent an axial direction in tire 100.

As shown in FIG. 1, tread 106 may include one or more ribs 110. Tread 106 may further include one or more circumferential grooves 112. Tread 106 may also include one or more axial grooves 114. Tread 106 may further include one or more sipes 116. Furthermore, tread 106 may include one or more channels 118.

Rib 110 may include a first axially-facing side and a second axially-facing side. “First” and “second” denote oppositely facing sides of rib 110. “Opposite” or “oppositely” describe a second feature that is positioned such that it is a mirror image of a first feature along a desired line of reflection, which may be any orientation relative to any tire direction. The line of reflection may be a circumferential centerline of rib 110. “Axially-facing” describes an orientation of a side of rib 110 that faces the axial direction in tire 100.

Rib 110 may include any of a variety of ribs within tread 106. In one example, rib 110 is a solid, continuous circumferential rib. “Continuous” describes a feature that extends entirely about or across tire 100, such as a rib 110 that extends about a circumference of tire 100. In another example, rib 110 is a solid, discontinuous circumferential rib. “Discontinuous” describes a feature that extends about or across a portion of tire 100 rather than the entirety of tire 100. A shape of rib 110 may be, but is not limited to, one of substantially linear, linear, zigzag, curved, curvilinear, serpentine, and irregular.

Rib 110 may also include any of a variety of arrangements along tread 106. In one example, tread 106 includes, but is not limited to, one or more of a shoulder rib 110, an intermediate rib 110, and a center rib 110. “Shoulder” describes a rib oriented nearest to shoulder region 108 of tire 100. “Intermediate” describes a rib arranged axially inward from a shoulder rib, yet axially offset from centerline CL of tire 100. “Center” is used to describe a rib oriented substantially along centerline CL of tire 100. In another example, as shown in FIG. 1, tread 106 includes opposing shoulder ribs 110, opposing intermediate ribs 110, and a center rib 110. In examples having a plurality of ribs 110, the plurality of ribs 110 may be one of equally and unequally axially-spaced relative to one another.

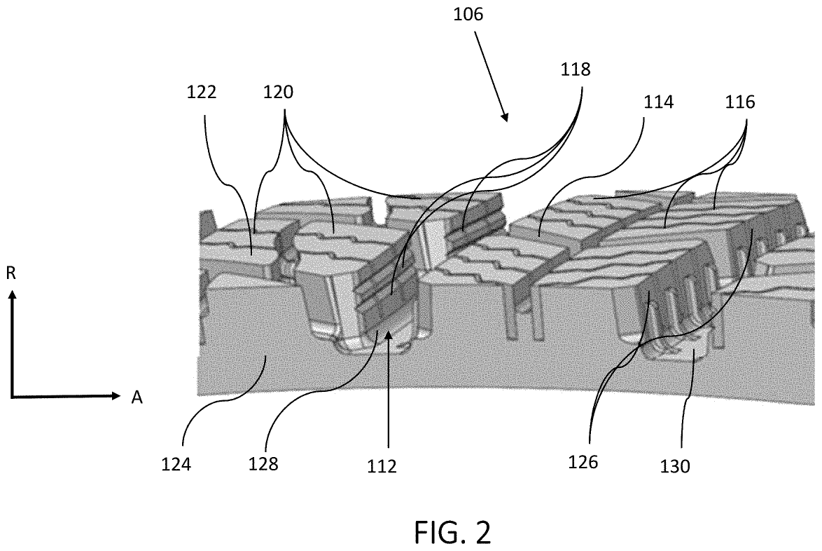

As illustrated in FIG. 2, rib 110 may be divided into a plurality of tread blocks 120. Tread block 120 may include a block tread surface 122, a block base 124, and one or more block sidewalls 126. Block tread surface 122 is a radially outermost ground-contacting surface of tread block 120. Block base 124 is a radially innermost surface of tread block 120 that interfaces with a carcass of tire 100. Block base 124 may be integral with the carcass of tire 100. Block tread surface 122 and block base 124 may be tangential to parallel and spatially aligned planes. Block sidewall 126 extends radially inward from block tread surface 122 to a groove bottom of one of circumferential groove 112 and axial groove 114. Block sidewall 126 defines an outer side surface of tread block 120, such as an axially-outer and/or a circumferentially-outer side surface of tread block 120.

Block sidewall 126 may include a sidewall base 128. Sidewall base 128 is a portion of block sidewall 126 that meets a groove bottom. In some examples, sidewall base 128 is normal to a groove bottom of one of circumferential groove 112 and axial groove 114. In other examples, sidewall base 128 includes a radius R_{S}, and thus, curves outwardly from block sidewall 126 and radially inward to a groove bottom of one of circumferential groove 112 and axial groove 114. In one example, radius R_{S} is about 2.5 mm. In a further example, radius R_{S} is 2.5 mm. In a further example, radius R_{S} is about 1.0 mm to about 4.0 mm. Radius R_{S} may be any value, for example, about 1.25 mm, 1.25 mm, about 3.0 mm, 3.8 mm, and the like. Additionally, Radius R_{S} may be in a range contained within the aforementioned range, for example, about 1.25 mm to about 3.0 mm, 1.5 mm to 3.5 mm, and the like.

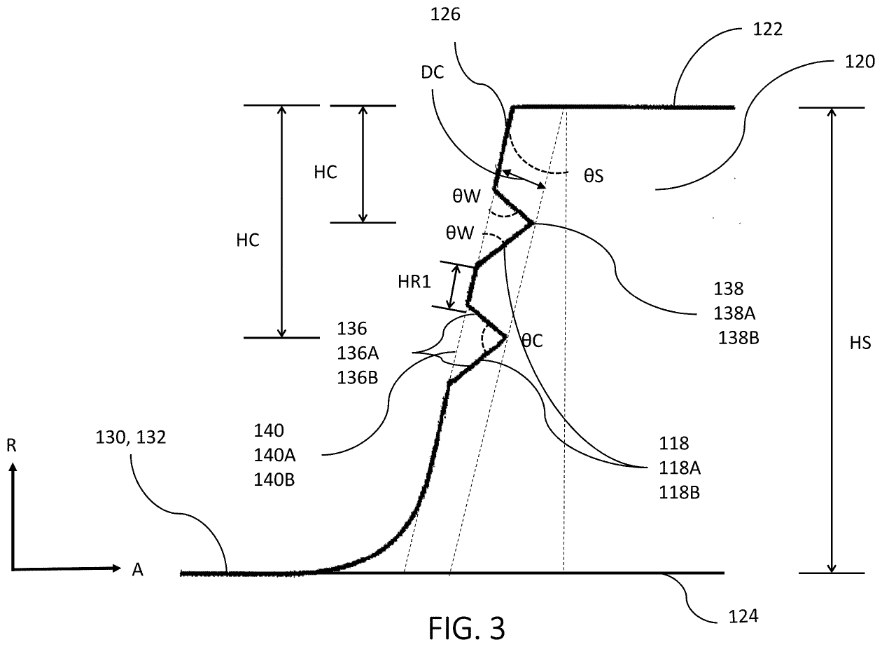

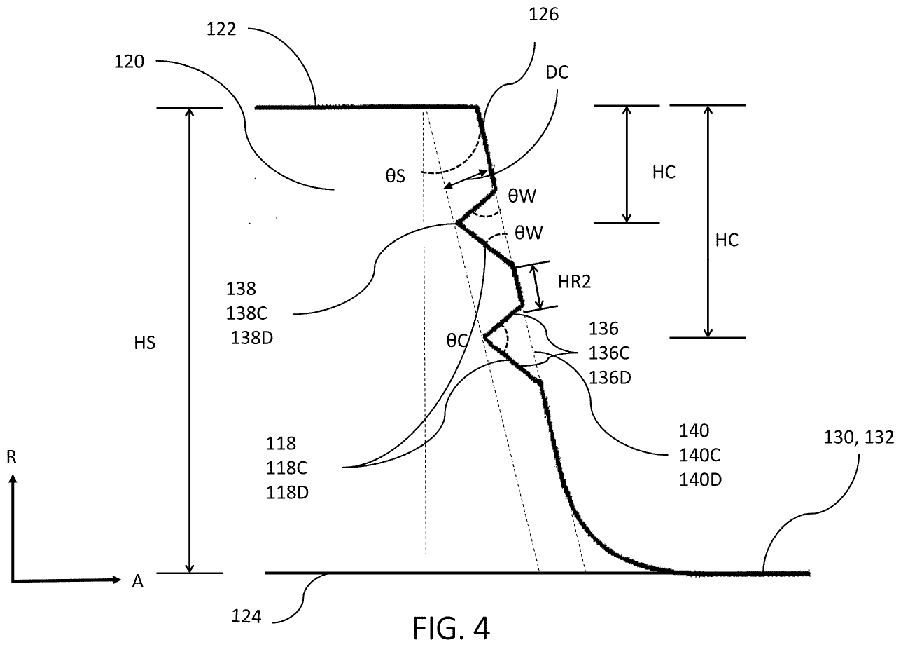

As illustrated in FIGS. 3 and 4, block sidewall 126 may include a height H_{S}. Height H_{S} is a distance between block tread surface 122 and block base 124 in the radial direction. Height H_{S} may include any of a variety of heights commonly found in tire tread patterns. In one example, height H_{S} is about 8.15 mm. In another example, height H_{S} is 8.15 mm. In a further example, height H_{S} is in a range from about 6.0 mm to about 10.0 mm. Height H_{S} may be any value, for example, 8.20 mm, 8.10 mm, and the like. Additionally, Radius H_{S} may be in a range contained within the aforementioned range, for instance, about 6.4 mm to about 9.1 mm, 8.0 mm to 9.0 mm, and the like.

Furthermore, block sidewall 126 may be inclined at an angle θ_{S} relative to the radial direction. In one example, angle θ_{S} is about 45.0 degrees. In an additional example, angle θ_{S} is 45.0 degrees. In another example, angle θ_{S} is in a range of about 25.0 degrees to about 65.0 degrees. Angle θ_{S} may be any value, for example, 45.2 degrees, 64.3 degrees, 25.0 degrees, and the like. Furthermore, angle θ_{S} may be in a range contained within the aforementioned range, for example, about 30.0 degrees to 50.0 degrees, about 40.0 degrees to about 55.0, 45.0 degrees to 47.0 degrees, and the like.

Block sidewall 126 may include any one of an assortment of configurations. An orientation of block sidewall 126 may be, but is not limited to, one of substantially axially-facing, axially-facing, substantially axially outward-facing (away from centerline CL of tire 100), axially outward facing, substantially axially inward-facing (toward centerline CL of tire 100), axially inward-facing, substantially circumferentially-facing, circumferentially-facing, diagonal (in a C-A plane and inclined relative to the A-axis of tire 100) and substantially outward-facing, and diagonal and substantially inward-facing.

In one example, block sidewall 126 includes a first axially-facing block sidewall and a second axially-facing block sidewall. In another example, block sidewall 126 includes a first axially-facing block sidewall and a second axially-facing block sidewall, where the first axially-facing block sidewall corresponds to a first axially-facing side of rib 110 and the second axially-facing block sidewall corresponds to a second axially-facing side of rib 110.

Referring to FIG. 2-4, circumferential groove 112 may include a circumferential groove bottom 130. Circumferential groove bottom 130 includes a portion of circumferential groove 112 that interfaces with the carcass of tire 100. Circumferential groove bottom 130 may be bound by the one or more block sidewalls 126 of the plurality of tread blocks 120.

Circumferential groove 112 may include any of a variety of circumferential grooves within tread 106. In one example, circumferential groove 112 is a continuous, circumferential groove. In another example, circumferential groove 112 is a discontinuous circumferential groove. In a further example, circumferential groove 112 includes a first circumferential groove and a second circumferential groove. A shape of circumferential groove 112 may be, but is not limited to, one or more of substantially linear, linear, zigzag, curved, curvilinear, serpentine, and irregular.

With reference to FIG. 1, circumferential groove 112 may have an axial width W_{G}. In some examples, width W_{G} varies along a length of circumferential groove 112. In other examples, width W_{G} remains constant along the length of circumferential groove 112. Width W_{G} may include any of a variety of widths commonly found in tire tread patterns. In one example, width W_{G} is about 25.0 mm or less. Width W_{G} may be any value, for example, 25.0 mm, 20.0 mm, about 18.2 mm, and the like. Furthermore, width W_{G} may be in a range contained within the aforementioned range, for example, about 10.0 mm to about 25.0 mm, 12.0 mm to 20.0 mm, and the like.

Circumferential groove 112 may include any of a variety of configurations on tread 106. In one example, a first circumferential groove 112 is contiguous to a second circumferential groove 112. In a further example, a plurality of circumferential grooves 112 may be one of equally and unequally circumferentially-spaced relative to one another. In another example, a plurality of circumferential grooves 112 may be one of substantially circumferentially aligned, circumferentially aligned, and circumferentially skewed relative to one another.

Rib 110 and circumferential groove 112 may include any of an assortment of configurations on tread 106. In one example, a first circumferential groove 112 is positioned on a first axially-facing side of rib 110, and a second circumferential groove 112 is positioned on a second axially-facing side of rib 110. In another example, each of a plurality of circumferential grooves 112 are positioned between contiguous pairs of a plurality of ribs 110. In a further example, as shown in FIG. 1, a circumferential groove 112 is positioned between each shoulder rib 110 and each contiguous intermediate rib 110, and further, between each intermediate rib 110 and a contiguous center rib 110.

As illustrated in FIGS. 3 and 4, axial groove 114 may include an axial groove bottom 132. Axial groove bottom 132 may include a portion of axial groove 114 that interfaces with the carcass of tire 100. Axial groove 114 may have a constant width along its length. Axial groove 114 may have a varying width along its length. Width of axial groove 114 may include any of a variety of widths commonly found in tire tread patterns. A shape of axial groove 114 may be, but is not limited to, one or more of substantially linear, linear, zigzag, curved, curvilinear, serpentine, and irregular.

Axial groove 114 may include any of a variety of configurations on tread 106. In some examples, a plurality of axial grooves 114 traverses rib 110, dividing rib 110 into a plurality of tread blocks 110. In one example, a plurality of axial grooves 114 are arranged to communicate with shoulder region 108, such that the plurality of axial grooves 114 extends substantially axially inward from shoulder region 108, across shoulder rib 110, to a contiguous circumferential groove 112. In another example, a plurality of axial grooves 114 are positioned to communicate with contiguous circumferential grooves 120, such that the plurality of axial grooves 114 extends across an intermediate rib 110 from one contiguous circumferential groove 112 to another, contiguous circumferential groove 112. In a further example, a plurality of axial grooves 114 are positioned to communicate with contiguous circumferential grooves 120, such that the plurality of axial grooves 114 extends across a center rib 110 from one contiguous circumferential groove 112 to another, contiguous circumferential groove 112.

In another example, each of a plurality of axial grooves 114 extends one of substantially axially inward and substantially axially outward from one of a shoulder region 108 and a circumferential groove 112 partially into one of a plurality of tread blocks 120, and thus, terminates within the tread block 120. In an additional example, a plurality of axial grooves 114 may be one of equally and unequally axially-spaced relative to one another. In another example, a plurality of axial grooves 114 may be one of substantially parallel, parallel, or skewed in the axial direction relative to one another. “Skewed” describes a plurality of features oriented such that no two features are parallel to one another and no two features intersect one another.

With reference to FIG. 2, sipe 116 may include any of an assortment of arrangements on tread 106. Specifically, sipe 116 may be provided on block tread surface 122. Sipe 116 may be radially oriented on tread block 120, such that sipe 116 extends radially inward from block tread surface 122 of tread block 120. In one example, sipe 116 extends radially inward from block tread surface 122 of tread block 120 and terminates a distance from block base 124. In another example, sipe 116 extends radially inward from block tread surface 122 of tread block 120 to block base 124.

As illustrated in FIG. 2, sipe 116 may include any of a variety of sipes within tread 106. In one example, sipe 116 is a discontinuous sipe that extends from block sidewall 126 and terminates within tread block 120. In another example, sipe 116 is a discontinuous sipe that extends from within tread block 120 and terminates within tread block 120, such as a mid-sipe having two closed ends within tread block 120. In a further example, sipe 116 traverses tread block 120 such that sipe 120 extends from one block sidewall 126 to any other block sidewall 126 of tread block 120.

Sipe 116 may be oriented in any of an assortment of positions on tread block 120. In one example, sipe 116 is oriented in any circumferential position on block tread surface 122. In another example, sipe 116 is oriented in any axial position on block tread surface 122. In a further example, sipe 116 is oriented in any axial and any circumferential position on block tread surface 122. Regarding a relative position, in examples having a plurality of sipes 116, the plurality of sipes 116 may be one of equally and unequally spaced relative to one another along block tread surface 122.

Sipe 116 may include any orientation on block tread surface 122. In one example, sipe 116 extends in the axial direction. In another example, sipe 116 extends in the circumferential direction. In a further example, sipe 116 extends at an angle relative to one of the axial direction and the circumferential direction. As to relative orientation, in examples having a plurality of sipes 116, the plurality of sipes 116 may be one of substantially parallel and parallel relative to one another on block tread surface 122. Alternatively, the plurality of sipes 116 may be one of substantially perpendicular and perpendicular relative to one another on block tread surface 122. In examples where a plurality of sipes 116 may be one of substantially perpendicular and perpendicular, depending on a position and variety of sipe 116, the plurality of sipes 116 may intersect on block tread surface 122.

A shape of sipe 116 may include, but is not limited to, one or more of substantially linear, linear, zigzag, wavy, bent, curved, curvilinear, serpentine, and irregular. Also, sipe 116 may include, but is not limited to, one or more of a sipe having a constant width, a varying width, a constant height, a varying height, a constant depth, and a varying depth.

As shown in FIG. 2, two substantially parallel and evenly-spaced wavy sipes 116 traverse tread block 120 in the substantially axial direction, such that they extend to each axially-facing block sidewall 126. Also shown in FIG. 2, three substantially parallel and evenly-spaced wavy sipes 116 traverse tread block 120 at an angle relative to the axial direction, such that they extend to each axially-facing block sidewall 126.

As illustrated in FIGS. 1-10, channel 118 may be include any of an assortment of arrangements on tread 106. Namely, channel 118 may be provided on block sidewall 126 of tread block 120. Channel 118 may include two walls 136. Channel 118 may include a corner 138. Walls 136 may extend from block sidewall 126 into tread block 120 to form corner 138 within tread block 120. Channel may have an opening 140 at one of a circumferential groove 112 and an axial groove 114.

Walls 136 may extend along multiple planes to define channel 118. To define a depth D_{C} of channel 118, each of walls 136 extends axially and radially from block sidewall 126 into tread block 120. Thus, corner 138 is offset from block sidewall 126.

Accordingly, depth D_{C} is an offset distance between block sidewall 126 and corner 138 along a plane that is normal to block sidewall 126. In one example, depth D_{C} is about 0.6 mm. In another example, depth D_{C} is 0.6 mm. In a further example, depth D_{C} is about 0.2 mm to about 1.0 mm. In an additional example, depth D_{C} is about 0.2 mm to about 1.5 mm. Depth D_{C} may be any value, for instance 0.8 mm, 0.2 mm, about 1.2 mm, and the like. Furthermore, depth D_{C} may include a range contained within any of the aforementioned ranges, for example, about 0.3 mm to about 0.7 mm, 0.4 mm to 0.6 mm, and the like.

As illustrated in FIGS. 3 and 4, each of walls 136 may extend from block sidewall 126 at an angle θ_{W}. Angle θ_{W} is an angle between each of walls 136 and block sidewall 126. Angle θ_{W} may be one of substantially the same and different between each of walls 136. In one example, angle θ_{W} is about 45.0 degrees. In another example, angle θ_{W} is 45.0 degrees. In a further example, angle θ_{W} is in a range from about 10.0 degrees to about 90.0 degrees. Angle θ_{W} may be any value, for example, 45.2 degrees, 60.0 degrees, 44.8 degrees, and the like. In addition, angle θ_{W} may include a range contained within the aforementioned range, for example, about 20.0 degrees to about 80.0 degrees, 40.0 degrees to 50.0 degrees, and the like.

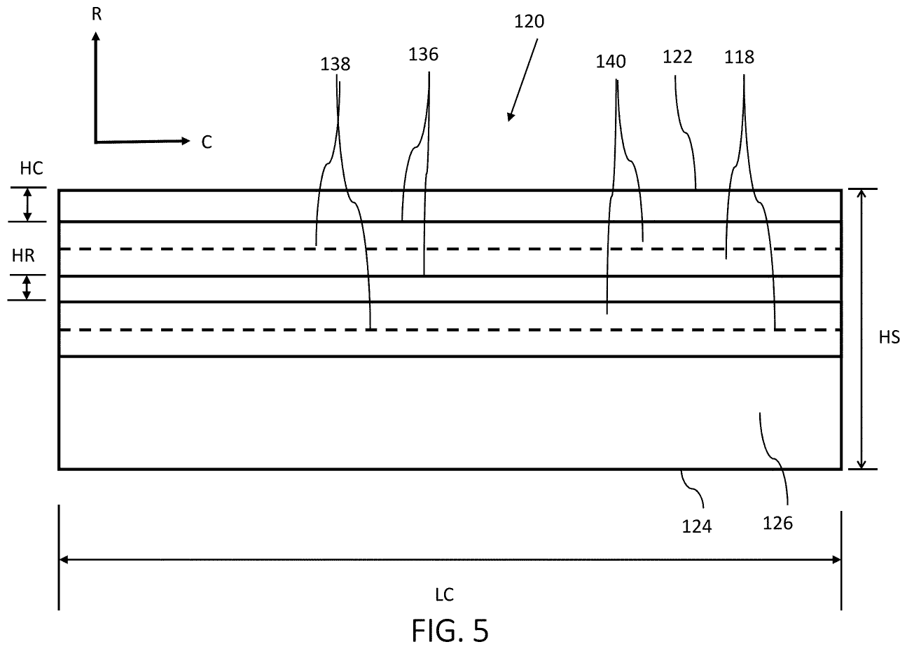

As illustrated in FIG. 5, to define a length L_{C} of channel 118, walls 136 extend one of substantially parallel and parallel to one another along block sidewall 126 of tread block 120. Walls 136 may extend along a portion of block sidewall 126, such that channel 118 includes opposing terminal ends located within boundaries of block sidewall 126. Alternatively, walls 136 may traverse block sidewall 126, such that channel 118 includes opposing terminal ends located at opposing intersections of block sidewall 126 and adjoining block sidewalls 126.

A sectional of each of walls 136 may include a linear or nonlinear profile. The profile of the sectional of walls 136 may be, but is not limited to, one of substantially straight, straight, bent, zigzagged, curved, convex, and concave.

As illustrated in FIGS. 3 and 4, corner 138 may include an angle θ_{C} between walls 136. In one example, angle θ_{C} is about 90.0 degrees. In another example, angle θ_{C} is 90.0 degrees. In a further example, angle θ_{C} is in a range from about 10.0 degrees to about 90.0 degrees. Angle θ_{C} may be any value, for example, 89.9 degrees, 90.2 degrees, 66.0 degrees, and the like. In addition, angle θ_{C} may include a range contained within the aforementioned range, for example, about 50.0 degrees to about 80.0 degrees, 80.0 degrees to 90.0 degrees, and the like.

A sectional of corner 138 may include a geometric profile. The profile of the sectional of corner 138 may be triangular, including one of an acute triangle, a right triangle, and an obtuse triangle.

Channel 118 may be provided at a radial position along block sidewall 126, such that channel 118 is radially offset from block tread surface 122 at a height H_{C}. Height H_{C} is a distance between block tread surface 122 and corner 138 along the radial direction. In one example, height H_{C} is about 2.0 mm. In another example, height H_{C} is 2.0 mm. In an additional example, height H_{C} is about 4.0 mm. In a further example, height H_{C} is 4.0 mm. In another example, height H_{C} is in a range from about 1.0 mm to about 7.0 mm. Height H_{C} may be any value, for instance, about 1.5 mm, 5.2 mm, 3.3 mm, and the like. Furthermore, height H_{C} may include a range contained within the aforementioned range, for example, about 2.0 mm to about 6.0 mm, 1.0 mm to 4.0 mm, and the like.

In addition, channel 118 may be oriented in any direction along block sidewall 126. In one example, channel 118 extends in a substantially circumferential direction to define a substantially circumferentially-extending channel 118. In another example, channel 118 extends in a circumferential direction to define a circumferentially-extending channel 118. In a further example, channel 118 extends inclined at an angle relative to the circumferential direction in a radially-positive or a radially-negative direction to define a radially-positive or a radially-negative circumferentially-extending channel 118. In another example, channel 118 extends in a substantially axial direction to define a substantially axially-extending channel 118. In a further example, channel 118 extends in an axial direction to define an axially-extending channel 118. In an additional example, channel 118 extends inclined at an angle relative to the axial direction in the radially-positive or radially-negative direction to define a radially-positive or a radially-negative axially-extending channel 118.

Channel 118 may be provided on one or more block sidewalls 126 tread block 120. In one example channel 118 is provided on a block sidewall 126 that faces a circumferential groove 112. In another example, channel 118 is provided on a block sidewall 126 that faces an axial groove 114. In a further example, channel 118 is provided on a first axially-facing block sidewall 126. In an additional example, channel 118 is provided on a second axially-facing block sidewall 126. In another example, channel 118 is provided on a substantially axially outward-facing block sidewall 120. In a further example, channel 118 is provided on an axially outward-facing block sidewall 126. In an additional example, channel 118 is provided on a substantially axially inward-facing block sidewall 126. In another example, channel 118 is provided on an axially inward-facing block sidewall 126. In yet another example, channel 118 is provided on a substantially circumferentially-facing block sidewall 126. In a further example, channel 118 is provided on a circumferentially-facing block sidewall 126. In another example, channel 118 is provided on a diagonal (in a C-A plane and inclined relative to the A-axis of tire 100) and substantially outward-facing block sidewall 126. In an additional example, channel 120 is provided on a diagonal and substantially inward-facing block sidewall 126. Channel 118 may be provided on any of the foregoing block sidewalls 126 of each of a plurality of tread blocks 120.

Additionally, channel 118 may be provided on one or more block sidewalls 126 of one or more tread blocks 120 of one or more ribs 110. In one example, channel 118 is provided on one or more block sidewalls 126 of one or more tread blocks 120 of a shoulder rib 110. In another example, channel 118 is provided on one or more block sidewalls 126 of one or more tread blocks 120 of an intermediate rib 110. In a further example, channel 118 is provided on one or more block sidewalls 126 of one or more tread blocks 120 of a center rib 110. In an additional example, channel 118 is provided on one or more block sidewalls 126 of one or more tread blocks 120 of each of opposing shoulder ribs 110. In another example, channel 118 is provided on one or more block sidewalls 126 of one or more tread blocks 120 of each of opposing intermediate ribs 110. In a further example, channel 118 is provided on one or more block sidewalls 126 of one or more tread blocks 120 of each of opposing shoulder ribs and opposing intermediate ribs 110. In an additional example, channel 118 is provided on one or more block sidewalls 126 of one or more tread blocks 120 of each of opposing shoulder ribs, opposing intermediate ribs, and a center rib 110.

Sipe 116 may extend to a block sidewall 126 including channel 118, such that sipe has a radial length along block sidewall 126. As a result, sipe 116 may intersect channel 118. In addition, a plurality of sipes 116 may extend to a block sidewall 126 including channel 118, such that each of the plurality of sipes 116 has a radial length along block sidewall 126. Accordingly, the plurality of sipes 116 may intersect channel 118. Depending on the radial position of channel 118 along block sidewall 126 and the radial length of sipe 116 along block sidewall 126, sipe 116 may one of intersect a portion of channel 118 and traverse channel 118.

Channel 118 may include a plurality of channels 118. In one example, a plurality of channels 118 is provided on block sidewall 126 of a tread block 120. In another example, a plurality of channels 118 is provided on a plurality of block sidewalls 126 of tread block 120. In another example, a plurality of channels 118 is provided on a block sidewall 126 of each of a plurality of tread blocks 120. In a further example, a plurality of channels 118 is provided on a block sidewall 126 of each of a plurality of tread blocks 120 of a rib 110. In yet another example, a plurality of channels 118 is provided on a block sidewall 126 of each of a plurality of tread blocks 120 of each of a plurality of ribs 110. In an additional example, a plurality of channels 118 is provided on a plurality of block sidewalls 126 of each of a plurality of tread blocks 120 of a rib 110. In another example, a plurality of channels 118 is provided on a plurality of block sidewalls 126 of each of a plurality of tread blocks 120 of each of a plurality of ribs 110.

In one example, a plurality of channels 118 includes a first channel 118A and a second channel 118B. First and second channels 118A and 118B are consistent with the foregoing description of channel 118. Accordingly, first channel 118A includes first walls 136A, a first corner 138A, and a first opening 140A. Likewise, second channel 118B includes second walls 136B, a second corner 138B, and a second opening 140B. First channel 118A and second channel 118B may include one of substantially identical dimensions and different dimensions relative to one another. Further, first channel 118A and second channel 118B may include one of substantially similar orientations (i.e. substantially circumferentially extending, circumferentially-extending, and axially-extending), such that they are one of substantially parallel and parallel, and different orientations along block sidewall 126 relative to one another, such that they are skewed.

First channel 118A is provided on a first axially-facing block sidewall 126 of tread block 120, such that first opening 140A is at a first circumferential groove 112. First channel 118A is radially offset from block tread surface 122 at height H_{C}. Height H_{C} may be about 2.0 mm. Each of first walls 136A extends axially and radially from first axially-facing block sidewall 126 into tread block 120 such that first walls 136A intersect to form first corner 138A. First corner 138A may have about a 90.0 degree angle, a 90.0 degree angle, or any acute or obtuse angle. Each of first walls 136A also includes a length L_{C}, such that first walls 136A extend one of substantially parallel and parallel to one another along block sidewall 126 of tread block 120.

Second channel 118B may be provided on first axially-facing block sidewall 126 of tread block 120, such that second opening 140B is at first circumferential groove 112. First channel 118A is radially offset from block tread surface 122 at height H_{C}. Height H_{C} may be about 4.0 mm. Also, second channel 118B is positioned radially inward of first channel 118A, such that first channel 118A and second channel 118B are separated by a radially-extending portion of first axially-facing block sidewall 126 having a height H_{R1}. Height H_{R1} is a distance between a radially innermost first wall 136A and a radially outermost second wall 136B along a plane tangential to first axially-facing block sidewall 126. Height H_{R1} may be about 0.786 mm. The radially-extending portion of first axially-facing block sidewall 126 may be, but is not limited to, one of substantially straight, straight, wavy, curved, convex, and concave. Each of second walls 136B extends axially and radially from first axially-facing block sidewall 126 into tread block 120 such that second walls 136B intersect to form second corner 138B. Second corner 138B may have about a 90.0 degree angle, a 90.0 degree angle, or any acute or obtuse angle. Each of second walls 136B also includes a length L_{C}, such that second walls 136B extend one of substantially parallel and parallel to one another along block sidewall 126 of tread block 120.

The foregoing example, including first and second channels 118A and 118B may be applied to any block sidewall 126 of any tread block 120 of any rib 110. In one example, first and second channels 118A and 118B are correspondingly provided on a block sidewall 126 of each tread block 120 of an intermediate rib 110. In another example, first and second channels 118A and 118B are correspondingly provided on a block sidewall 126 of each tread block 120 of a shoulder rib 110. In a further example, first and second channels 118A and 118B are correspondingly provided on a block sidewall 126 of each tread block 120 of a center rib 110. In another example, first and second channels 118A and 118B are correspondingly provided on each tread block 120 of each of opposing intermediate ribs 110. In an additional example, first and second channels 118A and 118B are correspondingly provided on a block sidewall 126 of each tread block 120 of each of opposing shoulder ribs 110. In a further example, first and second channels 118A and 118B are correspondingly provided on a block sidewall 126 of each tread block 120 of each of opposing shoulder ribs 110 and opposing intermediate ribs 110. In yet a further example, first and second channels 118A and 118B are correspondingly provided on a block sidewall 126 of each tread block 120 of each of opposing shoulder ribs 110, opposing intermediate ribs 110, and a center rib 110. In another example, first and second channels 118A and 118B are correspondingly provided on a block sidewall 126 of each tread block 120 of each of opposing shoulder ribs 110 and a center rib 110. In an additional example, first and second channels 118A and 118B are correspondingly provided on a block sidewall 126 of each tread block 120 of each of opposing intermediate ribs 110 and a center rib 110.

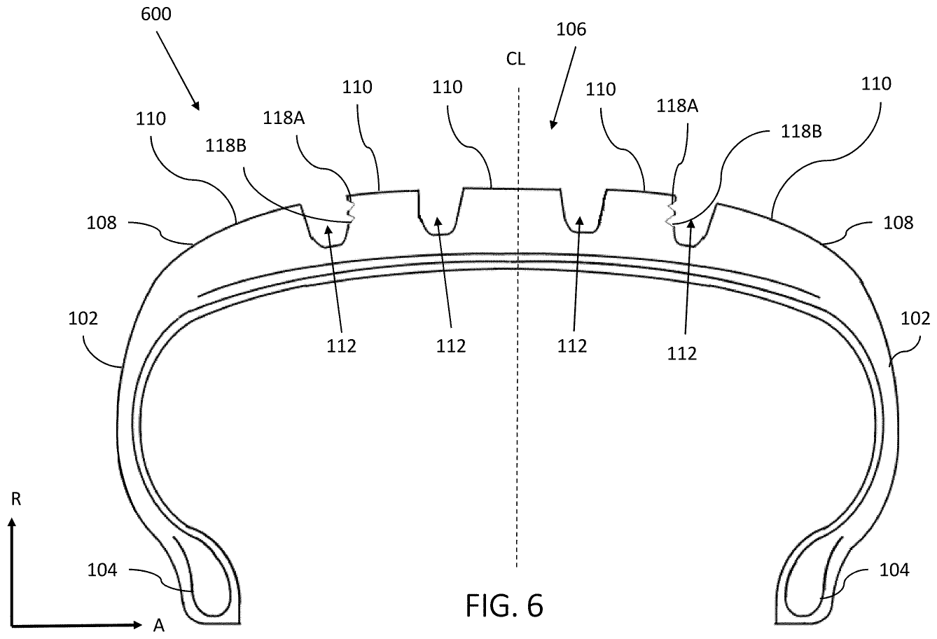

FIG. 6 illustrates a tire 600 in which first and second channels 118A and 118B are oriented only on axially-outwardly facing sides of intermediate ribs 110. First and second channels 118A and 118B are oriented in pairs on the same side of rib 110 at different radial heights.

In another example, in addition to first channel 118A and second channel 118B described above, the plurality of channels 118 includes a third channel 118C. Third channel 118C may be positioned oppositely to one of first channel 118A and second channel 118B on tread block 120.

Like first and second channels 118A and 118B, third channel 118C is consistent with the foregoing description of channel 118. Accordingly, third channel 118C includes third walls 136C, a third corner 138A, and a third opening 140A. Third channel 118C may include one of substantially similar dimensions and different dimensions relative to first channel 118A and/or second channel 118B. Further, third channel 118C may include one of substantially similar orientations (i.e. substantially circumferentially extending, circumferentially-extending, and axially-extending) and different orientations along block sidewall 126 relative to first channel 118A and/or second channel 118B, respectively.

Third channel 118C is provided on a second axially-facing block sidewall 126 (oppositely facing relative to first axially-facing block sidewall) of tread block 120, such that third opening 140C is at a second circumferential groove 112. Third channel 118C is radially offset from block tread surface 122 at height H_{C}. Height H_{C} may be one of commensurate with height H_{C} of first channel 118A, second channel 118B, and about 2.0 mm. Each of third walls 136C extends axially and radially from second axially-facing block sidewall 126 into tread block 120 such that third walls 136C intersect to form third corner 138C. Third corner 138C may have about a 90.0 degree angle, a 90.0 degree angle, or any acute or obtuse angle. Each of third walls 136C also includes a length L_{C}, such that third walls 136C extend one of substantially parallel and parallel to one another along block sidewall 126 of tread block 120.

The foregoing example, including first, second, and channels 118A-118C may be applied to any opposing block sidewalls 126 of any tread block 120 of any rib 110. In one example, first, second, and third channels 118A-118C are correspondingly provided on opposing block sidewalls 126 of each tread block 120 of an intermediate rib 110. In another example, first, second, and third channels 118A-118C are correspondingly provided on opposing block sidewalls 126 of each tread block 120 of a shoulder rib 110. In a further example, first, second, and third channels 118A-118C are correspondingly provided on opposing block sidewalls 126 of each tread block 120 of a center rib 110. In another example, first, second, and third channels 118A-118C are correspondingly provided on opposing block sidewalls 126 of each tread block 120 of each of opposing intermediate ribs 110. In an additional example, first, second, and third channels 118A-118C are correspondingly provided on opposing block sidewalls 126 of each tread block 120 of each of opposing shoulder ribs 110. In a further example, first, second, and third channels 118A-118C are correspondingly provided on opposing block sidewalls 126 of each tread block 120 of each of opposing shoulder ribs 110 and each of opposing intermediate ribs 110. In yet a further example, first, second, and third channels 118A-118C are correspondingly provided on opposing block sidewalls 126 of each tread block 120 of each of opposing shoulder ribs 110, each of opposing intermediate ribs 110, and a center rib 110. In another example, first, second, and third channels 118A-118C are correspondingly provided on opposing block sidewalls 126 of each tread block 120 of each of opposing shoulder ribs 110 and a center rib 110. In an additional example, first, second, and third channels 118A-118C are correspondingly provided on opposing block sidewalls 126 of each tread block 120 of each of opposing intermediate ribs 110 and a center rib 110.

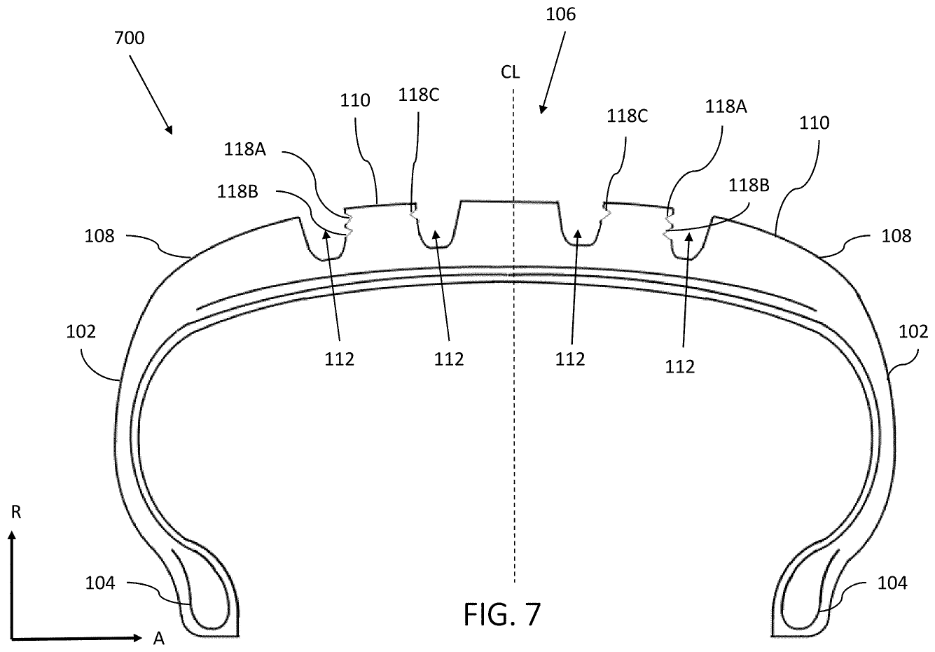

FIG. 7 illustrates a tire 700 in which first and second channels 118A and 118B are oriented on axially-outwardly facing sides of intermediate ribs 110 and third channel 118C is oriented on an axially-inward facing side of intermediate ribs 110. First and second channels 118A and 118B are oriented in a pair on the same side of rib 110 at different radial heights. Third channel 118C is oriented at the same radial height as first channel 118A.

In a similar example, in addition to first channel 118A, second channel 118B, and third channel 118C described above, the plurality of channels 118 includes a fourth channel 118D. Fourth channel 118D may be positioned oppositely to second channel 118B, respectively, on tread block 120.

Like first, second, and third channels 118A-118C, fourth channel 118D is consistent with the foregoing description of channel 118. Accordingly, fourth channel 118D includes fourth walls 136D, a fourth corner 138D, and a fourth opening 140D. Fourth channel 118D may include one of substantially similar dimensions and different dimensions relative to first, second, and/or third channels 118A-118C. Further, fourth channel 118C may include one of substantially similar orientations (i.e. substantially circumferentially extending, circumferentially-extending, and axially-extending) and different orientations along block sidewall 126 relative to first, second, and/or third channels 118A-118C.

Fourth channel 118D is provided on second axially-facing block sidewall 126 of tread block 120, such that fourth opening 140D is at second circumferential groove 112. Fourth channel 118D is positioned radially inward of third channel 118A, such that its radial position is commensurate with that of second channel 118B. Additionally, third channel 118C and fourth channel 118D are separated by a radially-extending portion of second axially-facing block sidewall 126 having height H_{R2}. Height H_{R2} is a distance between a radially innermost third wall 136C and a radially outermost fourth wall 136D along a plane tangential to block sidewall 126. Height H_{R2} may be commensurate with height H_{R1}. Height H_{R2} may be about 0.786 mm. The radially-extending portion of second axially-facing block sidewall 126 may be, but is not limited to, one of substantially straight, straight, wavy, curved, convex, and concave. Each of fourth walls 136D extends axially and radially from second axially-facing block sidewall 126 into tread block 120 such that fourth walls 136D intersect to form fourth corner 138D. Fourth corner 138D may have about a 90.0 degree angle, a 90.0 degree angle, or any acute or obtuse angle. Each of fourth walls 136D also includes a length L_{C}, such that fourth walls 136D extend one of substantially parallel and parallel to one another along block sidewall 126 of tread block 120.

The foregoing example, including first, second, third, and fourth channels 118A-118D may be applied to any opposing block sidewalls 126 of any tread block 120 of any rib 110. In one example, first, second, third, and fourth channels 118A-118D are correspondingly provided on opposing block sidewalls 126 of each tread block 120 of an intermediate rib 110. In another example, first, second, third, and fourth channels 118A-118D are correspondingly provided on opposing block sidewalls 126 of each tread block 120 of a shoulder rib 110. In a further example, first, second, third, and fourth channels 118A-118D are correspondingly provided on opposing block sidewalls 126 of each tread block 120 of a center rib 110. In another example, first, second, third, and fourth channels 118A-118D are correspondingly provided on opposing block sidewalls 126 of each tread block 120 of each of opposing intermediate ribs 110. In an additional example, first, second, third, and fourth channels 118A-118D are correspondingly provided on opposing block sidewalls 126 of each tread block 120 of each of opposing shoulder ribs 110. In a further example, first, second, third, and fourth channels 118A-118D are correspondingly provided on opposing block sidewalls 126 of each tread block 120 of each of opposing shoulder ribs 110 and each of opposing intermediate ribs 110. In yet a further example, first, second, third, and fourth channels 118A-118D are correspondingly provided on opposing block sidewalls 126 of each tread block 120 of each of opposing shoulder ribs 110, each of opposing intermediate ribs 110, and a center rib 110. In another example, first, second, third, and fourth channels 118A-118D are correspondingly provided on opposing block sidewalls 126 of each tread block 120 of each of opposing shoulder ribs 110 and a center rib 110. In an additional example, first, second, third, and fourth channels 118A-118D are correspondingly provided on opposing block sidewalls 126 of each tread block 120 of each of opposing intermediate ribs 110 and a center rib 110.

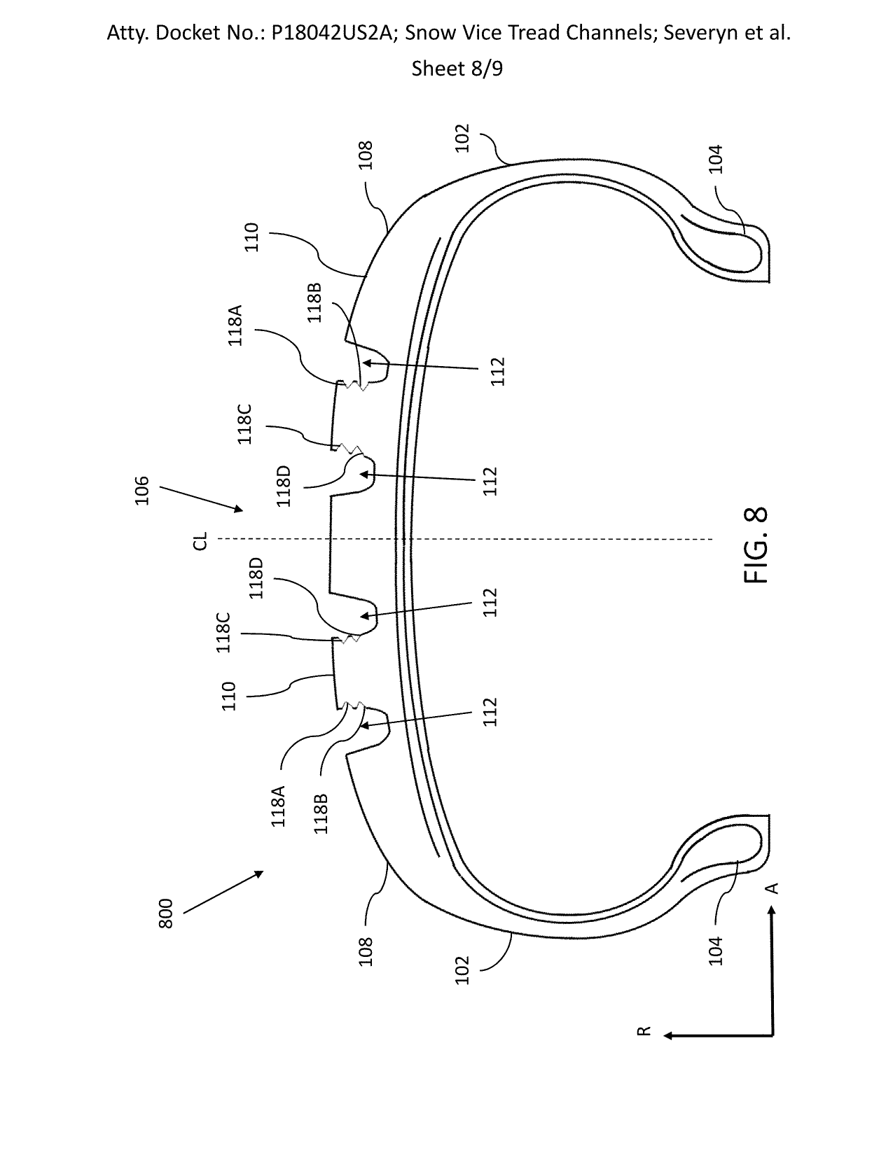

FIG. 8 illustrates a tire 800 in which channels 118A, 118B, 118C, and 118D are oriented in pairs (118A and 118B forming one pair, and 118C and 118D forming another pair) on opposing sides of intermediate ribs 110. Channels 118A and 118B are oriented in pairs facing axially-outwardly, while channels 118C and 118D are oriented in pairs facing axially-inwardly.

In another example, including first channel 118A and second channel 118B as detailed above, second channel 118B may instead be positioned oppositely to first channel 118A and on tread block 120. While first channel 118A is provided on the first axially-facing block sidewall 126 of tread block 120 as set forth above, second channel 118B is provided on a second axially-facing block sidewall 126 (oppositely facing relative to first axially-facing block sidewall) of tread block 120, such that second opening 140B is at a second circumferential groove 112. Second channel 118B is radially offset from block tread surface 122 at height H_{C}. Height H_{C} may be one of commensurate with height H_{C} of first channel 118A and about 2.0 mm. Each of second walls 136B extends axially and radially from second axially-facing block sidewall 126 into tread block 120 such that second walls 136B intersect to form second corner 138B. Second corner 138B may have about a 90.0 degree angle, a 90.0 degree angle, or any acute or obtuse angle. Each of second walls 136B also includes a length L_{C}, such that second walls 136B extend one of substantially parallel and parallel to one another along block sidewall 126 of tread block 120.

The foregoing example, including first and second channels 118A and 118B may be applied to any opposing block sidewalls 126 of any tread block 120 of any rib 110. In one example, first and second channels 118A and 118B are correspondingly provided on opposing block sidewalls 126 of each tread block 120 of an intermediate rib 110. In another example, first and second channels 118A and 118B are correspondingly provided on opposing block sidewalls 126 of each tread block 120 of a shoulder rib 110. In a further example, first and second channels 118A and 118B are correspondingly provided on opposing block sidewalls 126 of each tread block 120 of a center rib 110. In another example, first and second channels 118A and 118B are correspondingly provided on opposing block sidewalls 126 of each tread block 120 of each of opposing intermediate ribs 110. In an additional example, first and second channels 118A and 118B are correspondingly provided on opposing block sidewalls 126 of each tread block 120 of each of opposing shoulder ribs 110. In a further example, first and second channels 118A and 118B are correspondingly provided on opposing block sidewalls 126 of each tread block 120 of each of opposing shoulder ribs 110 and each of opposing intermediate ribs 110. In yet a further example, first and second channels 118A and 118B are correspondingly provided on opposing block sidewalls 126 of each tread block 120 of each of opposing shoulder ribs 110, each of opposing intermediate ribs 110, and a center rib 110. In another example, first and second channels 118A and 118B are correspondingly provided on opposing block sidewalls 126 of each tread block 120 of each of opposing shoulder ribs 110 and a center rib 110. In an additional example, first and second channels 118A and 118B are correspondingly provided on opposing block sidewalls 126 of each tread block 120 of each of opposing intermediate ribs 110 and a center rib 110.

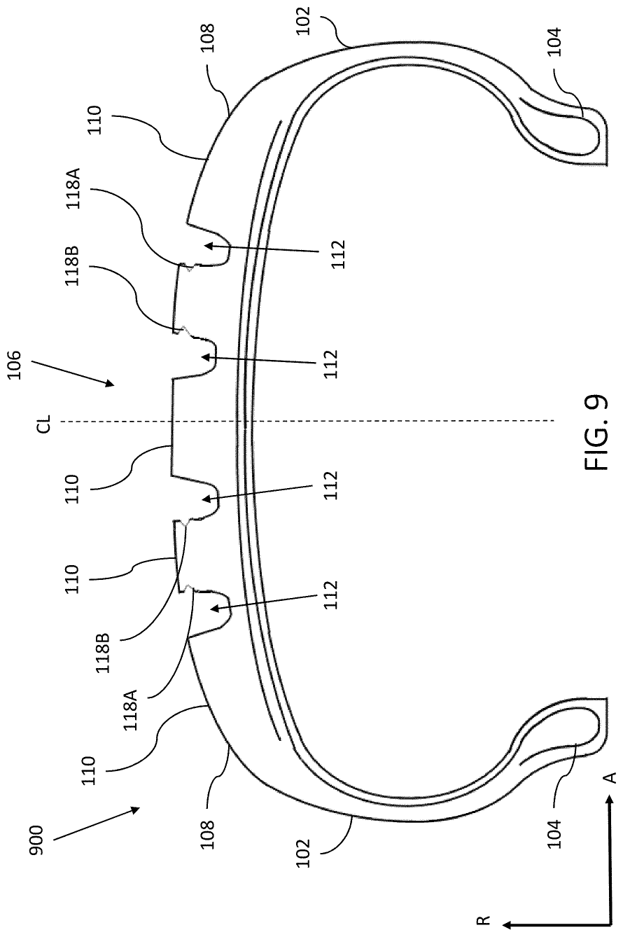

FIG. 9 illustrates a tire 900 in which first and second channels 118A and 118B are oriented on opposing sides of intermediate ribs 110. First and second channels 118A and 118B are oriented one per side on opposing sides of intermediate rib 110 at the same radial height.

Moreover, in any of the aforementioned examples, the plurality of channels 118 are not limited to four channels. The plurality of channels 118 may further include a fifth channel 118, a sixth channel 118, a seventh channel 118, an eight channel 118, and the like.

What have been described above are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A tire comprising:
a tread having:
a rib having a first axially-facing side and a second axially-facing side;
a plurality of axial grooves that traverse the rib, dividing the rib into a plurality of tread blocks,
wherein each tread block includes one or more block sidewalls;
wherein the one or more block sidewalls of each tread block includes
a first axially-facing block sidewall and a second axially-facing block sidewall;
a first circumferential groove positioned on the first axially-facing side of the rib;
a second circumferential groove positioned on the second axially-facing side of the rib; and
a first circumferentially-extending channel provided on the first axially-facing block sidewall of each tread block and having an opening at the first circumferential groove and a first corner within each tread block, the first channel being defined by two walls that extend from the block sidewall into each tread block and intersect to form the first corner having about a 90 degree angle.

2. The tire of claim 1, further comprising a second circumferentially-extending channel provided on the first axially-facing block sidewall of each tread block radially inward from the first channel, wherein the second channel has an opening at the first circumferential groove and a second corner within each tread block, the second channel being defined by two walls that extend from the block sidewall into each tread block and intersect to form the second corner having about a 90 degree angle.

3. The tire of claim 2, wherein the first channel and the second channel are separated by a radially-extending portion of the first axially-facing block sidewall.

4. The tire of claim 1, further comprising a second circumferentially-extending channel provided on the second axially-facing block sidewall of each tread block and having an opening at the second circumferential groove and a second corner within each tread block, the second channel being defined by two walls that extend from the block sidewall into each tread block and intersect to form the second corner having about a 90 degree angle.

5. The tire of claim 1, further comprising a plurality of circumferentially-extending channels provided on both the first axially-facing block sidewall and the second axially-facing block sidewall.

6. A tire comprising:
a tread having:
a rib having a first axially-facing side and a second axially-facing side;
a plurality of axial grooves that traverse the rib, dividing the rib into a plurality of tread blocks,
wherein each tread block includes one or more block sidewalls and a block tread surface,
wherein the one or more block sidewalls of each tread block includes a first axially-facing block sidewall and a second axially-facing block sidewall;
a first circumferential groove positioned on the first axially-facing side of the rib;
a second circumferential groove positioned on the second axially-facing side of the rib;
a first circumferentially-extending channel provided on the first axially-facing block sidewall of each tread block and having an opening at the first circumferential groove and a first corner within each tread block, the first channel being defined by two walls that extend from the block sidewall into each tread block and intersect to form the first corner having about a 90 degree angle; and
a second circumferentially-extending channel provided on the first axially-facing block sidewall of each tread block and having an opening at the first circumferential groove and a second corner within each tread block, the second channel being defined by two walls that extend from the block sidewall into each tread block and intersect to form the second corner having about a 90 degree angle, and
wherein the second channel is positioned radially inward from the first channel.

7. The tire of claim 6, further comprising a third circumferentially-extending channel provided on the second axially-facing sidewall of each tread block, wherein the third channel has an opening at the second circumferential groove and a third corner within each tread block, the third channel being defined by two walls that extend from the block sidewall into each tread block and intersect to form the third corner having about a 90 degree angle.

8. The tire of claim 7, further comprising a fourth circumferentially-extending channel provided on the second axially-facing sidewall of each tread block radially inward from the third channel, wherein the fourth channel has an opening at the second circumferential groove and a fourth corner within each tread block, the fourth channel being defined by two walls that extend from the block sidewall into each tread block and intersect to form the fourth corner having about a 90 degree angle.

9. The tire of claim 6, wherein the first channel and the second channel are separated by a radially-extending portion of the first axially-facing block sidewall.

10. The tire of claim 8, wherein the third channel and the fourth channel are separated by a radially-extending portion of the second axially-facing block sidewall.

11. A tire comprising:
a tread having:
a rib having a first axially-facing side and a second axially-facing side;
a plurality of axial grooves that traverse the rib, dividing the rib into a plurality of tread blocks,
wherein each tread block includes one or more block sidewalls and a block tread surface,
wherein the one or more block sidewalls of each tread block includes a first axially-facing block sidewall and a second axially-facing block sidewall;
a first circumferential groove positioned on the first axially-facing side of the rib;
a second circumferential groove positioned on the second axially-facing side of the rib;
a first circumferentially-extending channel provided on the first axially-facing sidewall of each tread block and having an opening at the first circumferential groove and a first corner within each tread block, the first channel being defined by two walls that extend from the block sidewall into each tread block and intersect to form the first corner having about a 90 degree angle; and
a second circumferentially-extending channel provided on the second axially-facing sidewall of each tread block and having an opening at the second circumferential groove and a second corner within each tread block, the second channel being defined by two walls that extend from the block sidewall into each tread block and intersect to form the second corner having about a 90 degree angle.

12. The tire of claim 11, further comprising a third circumferentially-extending channel provided on the first axially-facing sidewall of each tread block and having an opening at the first circumferential groove and a third corner within each tread block, the third channel being defined by two walls that extend from the block sidewall into each tread block and intersect to form the third corner having about a 90 degree angle.

14. The tire of claim 13, further comprising a fourth circumferentially-extending channel provided on the second axially-facing sidewall of each tread block as the third channel, and having an opening at the second circumferential groove and a fourth corner within each tread block, the fourth channel being defined by two walls that extend from the block sidewall into each tread block and intersect to form the fourth corner having about a 90 degree angle.

15. The tire of claim 12, wherein the first channel and the third channel are separated by a radially-extending portion of the first axially-facing block sidewall.

16. The tire of claim 14, wherein the second channel and the fourth channel are separated by a radially-extending portion of the second axially-facing block sidewall.

17. The tire of claim 1, wherein the one or more block sidewalls of each tread block includes a first circumferentially-facing block sidewall,
wherein a first axially-extending channel is provided on the first circumferentially-facing block sidewall of each tread block and having an opening at the axial groove and a first corner within each tread block, the first axially-extending channel being defined by two walls that extend from the block sidewall into each tread block and intersect to form the first corner having about a 90 degree angle.

18. The tire of claim 17, wherein the one or more block sidewalls of each tread block includes a second circumferentially-facing block sidewall that opposes the first circumferentially-facing block sidewall of each tread block,
wherein a second axially-extending channel is provided on the second circumferentially-facing block sidewall of each tread block and having an opening at the axial groove and a second corner within each tread block, the second axially-extending channel being defined by two walls that extend from the block sidewall into each tread block and intersect to form the second corner having about a 90 degree angle.

19. The tire of claim 6, wherein the one or more block sidewalls of each tread block includes a first circumferentially-facing block sidewall,
wherein a first axially-extending channel is provided on the first circumferentially-facing block sidewall of each tread block and having an opening at the axial groove and a first corner within each tread block, the first axially-extending channel being defined by two walls that extend from the block sidewall into each tread block and intersect to form the first corner having about a 90 degree angle.

20. The tire of claim 11, wherein the one or more block sidewalls of each tread block includes a first circumferentially-facing block sidewall,
wherein a first axially-extending channel is provided on the first circumferentially-facing block sidewall of each tread block and having an opening at the axial groove and a first corner within each tread block, the first axially-extending channel being defined by two walls that extend from the block sidewall into each tread block and intersect to form the first corner having about a 90 degree angle.
